(19) United States
(12) Patent Application Publication
(10) Pub. No.: US 2005/0041639 A1
(43) Pub. Date: Feb. 24, 2005

(54) Ip multimedia functionality identification

(76) Inventors: Tony Hulkkonen, Helsinki (FI); Juakko Rajanieml, Helsinki (FI); Mohan Sivanandan, Atlanta, GA (US); Markku Tuohino, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/494,209

(22) PCT Filed: Oct. 29, 2002
(86) PCT No.: PCT/IB02/04526

(30) Foreign Application Priority Data
Oct. 31, 2001 (GB) 0126129.6

(51) Int. Cl. H04L 12/66

(52) U.S. Cl. 370/352; 370/389

(57) ABSTRACT

A wireless communication network is disclosed having a circuit switched network architecture and a packet switched network architecture, at least part of the packet switched network architecture supporting IP multimedia functionality, wherein the support of IP multimedia functionality is identified in a pre-registration communication between a user and the network.

### FIELD OF THE INVENTION

The present invention relates to the mobile equipment supporting internet protocol multimedia functionality in a packet switched network. The invention relates particularly, but not exclusively, to a GPRS network.

### BACKGROUND OF THE INVENTION

In packet switched wireless communication systems, such as GPRS (General Packet Radio Service) networks, certain networks or parts of networks support internet protocol multimedia functionality. Thus mobile equipment which also supports such functionality, and which registers with such a network, may utilise multimedia applications. The network or part of the network that provides IP Multimedia functionality is referred to as the IP Multimedia Subsystem (IMS).

In the GPRS network structure packet switched network coverage overlays circuit switched network coverage, such that packet switched network coverage is provided in areas of the circuit switched network coverage, but coverage is not so comprehensive. As such, mobile equipment may be in an area provided with circuit switched network coverage but not with packet switched network coverage. Still further, not all packet switched networks, or parts thereof, provide IP multimedia functionality. As such even when packet switched network coverage is available, IP multimedia services may not be.

In current GPRS systems, the information provided in the broadcast control channel (BCCH) includes a local area code (LAC) identifying the circuit switched network and a routing area code (RAC) identifying the packet switched network. If there is no routing area code in the broadcast control channel, then obviously the mobile equipment can readily identify that no packet switched services exist, and as such no IP multimedia services are supported. The user equipment may then simply register with the circuit switched network for voice connections.

However, if the broadcast control channel does include a routing area code, then this is indicative of the availability of a packet switched network. However, the existence of the packet switched network provides no indication in itself as to whether IP multimedia functionality is available in that packet switched network.

In accordance with current GPRS networks, in order to determine whether IP Multimedia functionality is supported by the packet switched network, it is necessary to register with the network. In order to register with an IMS offering IP Multimedia functionality, the mobile equipment first performs a GPRS attachment, and then activates a packet data protocol (PDP) context or contexts. Thereafter, the user equipment must perform a CSCF discovery procedure. In the discovery procedure, the user equipment receives an address of a CSCF to which an IMS registration must be sent. An IMS registration may, for example, be a session initiation protocol (SIP) registration. Only when performing PDP context activation or CSCF discovery procedure, the user equipment is notified if the packet switched network does in fact not support IP multimedia functionality.

Thus, in existing GPRS services, the user equipment must register with the packet switched network before registration with an IMS can be attempted. Therefore there is a requirement to utilise a large amount of signalling, at the end of which it may be identified that IP multimedia services are not available.

It is an aim of the present invention to overcome the above stated problems. It is particularly an aim of the present invention to provide an improved technique for determining the availability of IP multimedia functionality in a network.

### SUMMARY OF THE INVENTION

In accordance with the present invention there is provided a method of indicating the functionality of a packet switched wireless network comprising transmitting, in a pre-registration communication, an indication of the IP Multimedia functionality of the packet switched network.

The pre-registration communication is a communication sent prior to initiation of the registration. Thus, in accordance with the present invention, before the registration is complete (i.e. pre-registration) the network sends a specific message to a wireless terminal including information of the services.

In this way, the invention allows a user to establish the existence of IP multimedia services without any need to attempt to attach to a GPRS network and activate a PDP context. In this way packet switched network resources are utilised more efficiently and also a user equipment can select an appropriate PLMN more rapidly.

The basic functionality offered by the network may be IP transport functionality, and IP multimedia functionality may be optionally available.

The availability of optional functionality may be indicated in a broadcast control signal. The functionality may be indicated in a transmission by the packet switched network identifying itself. The transmission may include a routing area code. The transmission may include packet data protocol context.

The method may be utilised in a GPRS network. The transmission may include a GPRS attach.

The invention further provides a wireless communication network having a circuit switched network architecture and a packet switched network architecture, at least part of the packet switched network architecture supporting IP multimedia functionality, wherein the support of IP multimedia functionality is identified in a pre-registration communication between a user and the network.

The pre-registration communication may comprise a transmission from radio access network to a user. The pre-registration communication may comprise a broadcast.

### BRIEF DESCRIPTION OF THE DRAWINGS

FIG. 1 illustrates an example topology of a circuit switched network over-layered with a packet switched network;

FIG. 2 illustrates an exemplary block level diagram of a system for implementing the network topology of FIG. 1; and

FIG. 3 illustrates an example of the adaptation of the broadcast control channel of a network transmission in accordance with one embodiment of the present invention.

### DESCRIPTION OF THE PREFERRED EMBODIMENTS

The invention will be described herein with reference to a particular, non-limiting example. The invention is not limited to such an example, and one skilled in the art will appreciate from the following the possibilities for the more general application of the present invention.

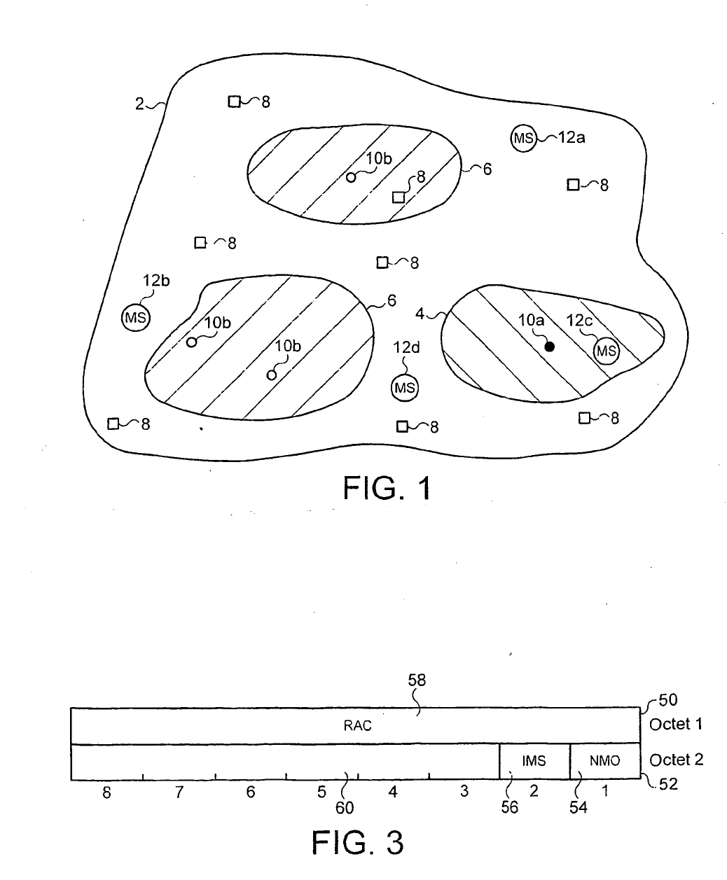

Referring to FIG. 1 there is illustrated an example of a circuit switched network coverage overlaid with areas of packet switched network coverage. The circuit switched coverage is generally illustrated by area 2. The packet switched coverage is generally illustrated by areas 6 and 4. Area 4 illustrates a packet switched area supporting IP multimedia functionality. The packet switched areas may or may not support IP multimedia functionality. In the example of FIG. 1 it is assumed that coverage area 4 supports IP multimedia functionality, and areas 6 do not. Further referring to FIG. 1 the square blocks 8 identify various base stations supporting the circuit switched network, and the circular blocks 10 identify the various base stations supporting the packet switched network(s). The solid circular blocks 10a represent base stations of a network supporting IP multimedia functionality, and the hollow circular blocks 10b represent those that do not. User equipment roams in the network, as represented by mobile stations 12. The mobile station 12c, as shown in FIG. 1, roams within the packet switched coverage area 4 of the base station 10a.

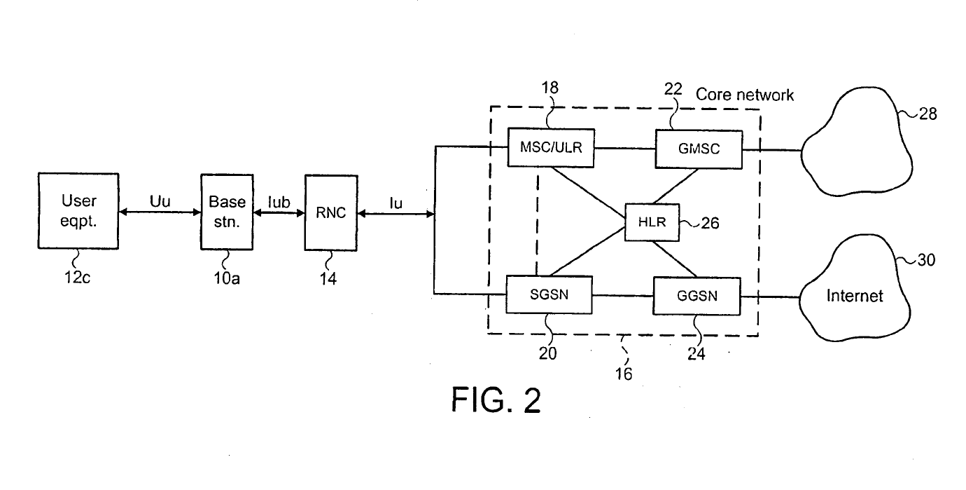

The present invention relates to any network infrastructure or core network providing coverage such that IP multimedia functionality is selectively provided. For the purposes of understanding the present invention, a particular example of a core network for supporting a routing area such as is shown in FIG. 1 is described hereinbelow with reference to FIG. 2. However, it should be understood that the invention is not limited to such an example of a core network.

More particularly, the present invention may be implemented for an Internet Protocol Multimedia subsystem (IMS).

Referring to FIG. 2, there is illustrated in block diagram form the main network element components of a system for supporting a routing area such as area 10a in FIG. 1. The user equipment 12c interfaces with the base station 10a over the air interface (Uu). The base station is connected to a radio network controller (RNC) 14 on the network side via an interface Iub. The RNC owns and controls the radio resources within its domain. The RNC 14 is connected to a core network 16 via interface Iu. The main elements of the core network 16 are illustrated in FIG. 2. The core network includes, for circuit switched functionality, a mobile services switching centre/visitor location register (MSC/VLR) 18 connected to the Iu interface and a gateway mobile services switching centre (GMSC) 22, which in turn is additionally connected to external circuit switched networks 28. For packet switched functionality, the core network includes a serving GPRS support node (SGSN) 20 connected to the Iu interface and a gateway GPRS support node (GGSN) 24, which in turn is connected to external packet switched networks 30. All elements of the core network 16 are additionally connected to a home location register (HLR) 26.

The circuit switched networks 28 provide circuit switched connections, such as ISDN and PSTN networks The packet switched external networks provide connections for data packet services, such as the internet. The data packet services include, in the present example for the network of FIG. 1, IP multimedia services.

The structure and operation of the network elements of the GPRS architecture illustrated in FIG. 2 are well-known to those skilled in the art, and as such no further detail will be discussed herein.

The implementation of an IMS core network will similarly be familiar to one skilled in the art. The IMS comprises all the core network elements for provision of IM services. The entities of the IM subsystem include the home subscriber server (HSS) and the call state control function (CSCF). The HSS contains subscription related information to support the network entities handling calls/sessions. The CSCF can act as an interrogating CSCF (I-CSCF), a proxy CSCF (P-CSCF) or a serving CSCF (S-CSCF). The P-CSCF is the first point of contact for a UE within the IMS. The S-cscf handles the session states in the network. The I-CSCF is mainly the contact point within an operator's network for all connections destined to a subscriber of that operator network. As stated hereinabove, the present invention is not limited to any particular network implementation, and the examples given herein are for the purposes of illustrating the broad applicability of the present invention.

All base stations 8, 10a and 10b of the network arrangement shown in FIG. 1 transmit information via a broadcast control channel (BCCH) which is used by user equipment within their domain. When user equipment decodes the information from the broadcast control channel of a particular base station, it uses the information, for example, to determine whether to connect to the network using the base station from which the broadcast control channel was received.

In current GPRS networks, the broadcast control channel includes the location area code for supporting circuit switched communication, and where appropriate the routing area code for supporting packet switched communication. As such the user equipment is able to determine, in accordance with whether circuit or packet switched network functionality is required, whether to connect to the network.

In accordance with the present invention, the broadcast control channel of a network element is adapted to further include an indication as to whether the packet switched network supports IP multimedia functionality.

In the preferred embodiment of the present invention, for a GPRS implementation, the core network (CN) packet switched domain specific GSM-MAP NAS system information element transmitted in the broadcast control channel is modified in order to implement the present invention. This two octet element is specified in 3GPP TS 24.008 version 5.x.x. The container and actual message in which this information is sent to the UE is specified in 3GPP TS 25.331.

The modification of this element is shown in FIG. 3.

The length of this element, as shown in FIG. 3, is two octets. The first octet 50, as is known in the art, contains the eight-bit field of the routing area code (RAC) 58. This field is the binary representation of the routing area code. Bit 8 in the first octet is the most significant bit.

The second octet 52 of this element contains the network mode of operation (NMO) field 54, which is a 1 bit field, in the least significant bit position. As known in the art, the setting of this field defines the network mode of operation. If the field is set to 1, network mode of operation II is set. If the field is set to 0, network mode of operation I is set.

The second octet of this element also contains, in accordance with an embodiment of the present invention, an internet multimedia support (IMS) field 56, which is also a 1 bit field, in the second least significant bit position. The setting of this field is the binary representation of the internet multimedia support. In this embodiment if the bit is set to 1, then this indicates that there is no internet multimedia support provided in the network. If the bit is set to 0, then this indicates that there is internet multimedia support in the network. It should be noted that this is an example implementation, and in practice the setting of the bits may be reversed, e.g. with bit set to 1 to identify internet multimedia support.

The bits 3 to 8 of the second octet, referenced as 60, are all spare, and are all preferably set to 0. The IMS field may alternatively be provided in any of the other spare bit positions of the second octet, and the indication of the 0 or 1 setting of the bit may be similarly reversed as discussed above.

Thus in accordance with the preferred embodiment of the present invention, the user equipment is able to identify through the broadcast control channel whether the network supports IP multimedia functionality at the same time that the presence of a packet switched network is identified. As such the signalling associated with user equipment looking to locate IP multimedia functionality is significantly reduced, as there is no requirement for the user equipment to perform unnecessary signalling connection establishment, GPRS attach, and PDP context activation attempts if the network does not support IP multimedia services. In addition, in the absence of IP multimedia functionality, the user equipment may connect directly to the mobile services switching centre in order to obtain voice services, rather than using up packet switch resources, if only voice services are required in the absence of any IP multimedia functionality.

It should be understood that the provision of information concerning the availability of IP multimedia functionality in accordance with the present invention, as discussed hereinabove, is only one possible way of providing such information. For example, the information may be conveyed in the GPRS attach or PDP context activation. However, these procedures may not have all the advantages of the preferred embodiment described herein as they require the user equipment to attach/activation before it is known whether the service is available.

It will be further understood by one skilled in the art that the invention is not limited in its applicability to GPRS networks. The invention may also be advantageously utilised in UMTS (universal mobile telecommunications services) terrestrial radio access networks. The specific implementation of the principles of the invention in such an alternative environment will be well within the scope of one skilled in the art.

Thus although the invention has been described herein with reference to particular embodiments and examples, it will be apparent that the applicability of the invention is significantly broader than that disclosed. One skilled in the art will appreciate that modifications may be made to the information provided herein whilst still remaining within the scope of the invention as defined by the appended claims.

1. A method of indicating the functionality of a packet switched wireless network comprising transmitting, in a pre-registration communication, an indication of the functionality of the packet switched network.

2. A method according to claim 1 wherein the functionality is Internet protocol functionality.

3. A method according to claim 2 wherein the Internet protocol functionality is Internet protocol multimedia functionality.

4. A method according to claim 1 wherein the functionality is identified in a broadcast control signal.

5. A method according to claim 1 wherein the functionality is identified in a transmission identifying the packet switched network.

6. A method according to claim 5 wherein the transmission includes a routing area code.

7. A method according to claim 1 wherein the transmission includes packet data protocol context.

8. A method according to claim 1 utilised in a GPRS network.

9. A method according to claim 8 wherein the transmission includes a GPRS context.

10. A wireless communication network having a circuit switched network architecture and a packet switched network architecture, at least part of the packet switched network architecture supporting IP multimedia functionality, wherein the support of IP multimedia functionality is identified in a pre-registration communication between a user and the network.

11. A wireless communication network according to claim 10 wherein the pre-registration communication comprises a transmission from the packet switched network architecture to a user.

12. A wireless communication network according to claim 10 wherein the pre-registration communication comprises a broadcast.
